(19) United States
(12) Patent Application Publication
(10) Pub. No.: US 2017/0244685 A1
(43) Pub. Date: Aug. 24, 2017

(54) MULTIPATH DEMULTIPLEXED NETWORK ENCRYPTION

(71) Applicant: Thalonet, Inc. d/b/a Haste, Atlanta, GA (US)

(72) Inventors: Taric Mirza, Atlanta, GA (US); Gaige Bradley Paulsen, Washington, DC (US)

(21) Appl. No.: 15/172,349

(22) Filed: Jun. 3, 2016

Related U.S. Application Data
(60) Provisional application No. 62/173,679, filed on Jun. 10, 2015.

(51) Int. Cl. H04L 29/06

(52) U.S. Cl. CPC H04L 63/061; H04L 63/0281

(57) ABSTRACT

An encryption application splits a data payload into multiple segments. Each of the segments is encoded using one of multiple encryption keys. The encryption keys may be selected from a pool of encryption keys tied to a user account. The encrypted segments are transmitted to a network destination using multiple parallel network paths.

### CROSS-REFERENCE TO RELATED APPLICATIONS

This application is a continuation of and claims priority to U.S. Application Ser. No. 62/173,679 titled “MULTIPATH DEMULTIPLEXED NETWORK ENCRYPTION”, filed Jun. 10, 2015, which is incorporated herein by reference in its entirety.

### BACKGROUND

Network communications may be encrypted to obfuscate sensitive data traversing the network. Some encrypted communications may be vulnerable to a man-in-the-middle attack, or other attacks.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a flow chart illustrating an example of functionality of a computing environment employed in the networked environment of FIG. 1 according to various embodiments of the present disclosure.

FIG. 3 is a flow chart illustrating an example of functionality of a client employed in the networked environment of FIG. 1 according to various embodiments of the present disclosure.

FIG. 4 is a schematic block diagram that provides one example illustration of a computing environment employed in the networked environment of FIG. 1 according to various embodiments of the present disclosure.

### DETAILED DESCRIPTION

Parties wishing to exchange confidential or sensitive data over a network may encrypt these communications. The encrypted communications are then obfuscated to those who do not possess the required key or keys to decrypt the communications. However, such an approach is still vulnerable to attack, particularly when the encrypted communications traverse a single known network path. For example, a malicious third party can perform a man-in-the-middle attack by intercepting exchanged encryption keys. The third party can forward keys to the communicating parties accessible to the third party, thereby allowing the third party to decrypt data exchanged between the communicating parties.

An encryption algorithm divides a data payload into multiple segments. The segments are then each encrypted with a respective encryption key. A party attempting to decrypt the segments would then require each of the respective encryption keys, or private keys corresponding to each of the respective encryption keys. The segments are then communicated to a recipient along respective parallel network paths, preventing a third party from intercepting all of the segments if only one of the network paths has been compromised. Additional segments may also be communicated to the recipient encoded to purposefully fail an integrity check, such as a cyclic redundancy check or hash. Thus, a party intercepting a segment with a failing integrity check would attempt to reconstruct the payload using invalid data.

In the following discussion, a general description of the system and its components is provided, followed by a discussion of the operation of the same.

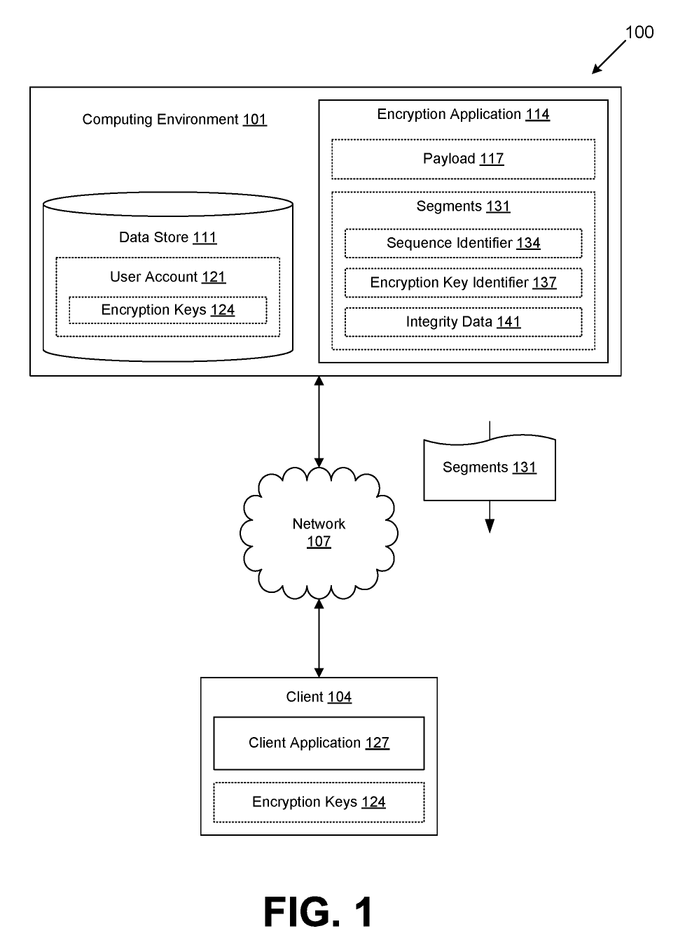

With reference to FIG. 1, shown is a networked environment 100 according to various embodiments. The networked environment 100 includes a computing environment 101 and a client 104, which are in data communication with each other via a network 107. The network 107 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 101 may comprise, for example, a server computer or any other system providing computing capability. Alternatively, the computing environment 101 may employ a plurality of computing devices that may be arranged, for example, in one or more server banks or computer banks or other arrangements. Such computing devices may be located in a single installation or may be distributed among many different geographical locations. For example, the computing environment 101 may include a plurality of computing devices that together may comprise a hosted computing resource, a grid computing resource and/or any other distributed computing arrangement. In some cases, the computing environment 101 may correspond to an elastic computing resource where the allotted capacity of processing, network, storage, or other computing-related resources may vary over time.

Various applications and/or other functionality may be executed in the computing environment 101 according to various embodiments. Also, various data is stored in a data store 111 that is accessible to the computing environment 101. The data store 111 may be representative of a plurality of data stores 111 as can be appreciated. The data stored in the data store 111, for example, is associated with the operation of the various applications and/or functional entities described below.

The components executed on the computing environment 101, for example, include an encryption application 114, and other applications, services, processes, systems, engines, or functionality not discussed in detail herein. The encryption application 114 is executed to encrypt a data payload 117 for communication to a client 104 via the network 107.

The data stored in the data store 111 includes, for example, user accounts 121, and potentially other data. User accounts 121 comprise data associated with one or more users accessing functionality implemented in the computing environment 101. User accounts 121 may comprise, for example, login information such as usernames or passwords to authenticate a user attempting to access the computing environment 101. The user accounts 121 may also comprise contact information such as a mailing address, email address, phone number or other contact information. User accounts 121 may also comprise user preferences embodying settings, configurations, or other preferences used in interactions with the computing environment 101. Each of the user accounts 121 is associated with one or more encryption keys 124. In some embodiments, the encryption keys 124 may each be unique with respect to a user account 121. In other embodiments, the combination of encryption keys 124 of a user account 121 may be unique with respect to other user accounts 121. The encryption keys 124 may include, for example, keys facilitating a symmetric encryption algorithm, an asymmetric encryption algorithm, or other encryption algorithm as can be appreciated.

The client 104 is representative of a plurality of client devices that may be coupled to the network 107. The client 104 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 104 may include a display. The display may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client 104 may be configured to execute various applications such as a client application 127 and/or other applications. The client application 127 may be executed in a client 104, for example, to access network content served up by the computing environment 101 and/or other servers, thereby rendering a user interface on the display. To this end, the client application 127 may comprise, for example, a browser, a dedicated application, etc., and the user interface may comprise a network page, an application screen, etc. The client 104 may be configured to execute applications beyond the client application 127 such as, for example, email applications, social networking applications, word processors, spreadsheets, and/or other applications.

Next, a general description of the operation of the various components of the networked environment 100 is provided. To begin, the client 104 authenticates with the computing environment 101 using a user account 121. This may include communicating authentication credentials or other data facilitating the access of functionality implemented in the computing environment 101. The encryption application 114 is queried to communicate a payload 117 to the client 104 via the network 107. The encryption application 114 may be queried by an application, service, or other operation executed in the computing environment 101. The encryption application 114 may also be queried by a third party service executed in a distinct computing environment. The payload 117 includes all or a portion of a data object to be communicated to the client 104.

The encryption application 114 then accesses the encryption keys 124 of the user account 121 with which the client 104 is authenticated. The encryption application 114 then encrypts the payload 117 using a selected encryption key 124. In some embodiments, the encryption key 124 may be predefined for encrypting a payload 117. In other embodiments, the encryption key 124 may be randomly selected from encryption keys 124 of the user account 121, or selected by another approach. To encrypt the payload 117, the encryption application 114 may apply a symmetric key algorithm, asymmetric key algorithm, or other encryption algorithm as can be appreciated.

The encryption application 114 then divides the encrypted payload 117 into multiple segments 131. In some embodiments, the encryption application 114 generates the segments 131 by dividing the payload 117 into segments 131 of a predefined size. In other embodiments, the encryption application 114 generates the segments 131 by dividing the payload 117 into segments 131 of varying size. In further embodiments, the encryption application 114 generates the segments 131 by dividing the payload 117 into a predefined number of segments 131. The segments 131 may also be generated by another approach.

Next, the encryption application 114 encrypts each of the segments 131 using respective ones of the encryption keys 124. Thus, each of the segments 131 is encrypted using one of many encryption keys 124 for a user account 121, and multiple encryption keys 124 are used to encrypt the segments 131 of a given payload 117. In some embodiments, the encryption key 124 used to encrypt a segment may be randomly selected or selected according to a predefined sequence of encryption keys 124. For example, the encryption key 124 may be selected from an ordered collection of encryption keys 124 by applying a modulo operation to a number of available encryption keys 124 and sequence identifier 134. The sequence identifier 134 is discussed in further detail below.

In some embodiments, the encryption application 114 may also add metadata to each of the segments 131. Such metadata may include, for example, a sequence identifier 134. The sequence identifier 134 indicates an order of the segment 131 with respect to the payload 117. Thus, the payload 117 can be reassembled according to an order of the segments 131 indicated by the sequence identifier 134. The sequence identifier 134 may also indicate a total number of segments 131 for a given payload 117. As a non-limiting example, a sequence identifier 134 may identify a segment 131 as the first of one hundred segments 131 for a given payload 117.

The metadata added to the segments 131 may also include an encryption key identifier 137. In embodiments in which the segments 131 are encrypted using symmetric key encryption, the encryption key identifier 137 may indicate a corresponding one of the encryption keys 124 used to encrypt a given segment 131. In embodiments in which the segments 131 are encrypted using asymmetric key encryption, the encryption key identifier 137 may indicate a private encryption key 124 corresponding to a public encryption key 124 used to encrypt a given segment 131. For example, the encryption key identifier 137 may include a unique identifier or reference allowing the corresponding encryption key 124 to be selected from a relational database, repository, or other source. The metadata may also include integrity data 141 comprising a value or code generated by the application of an integrity algorithm such as a cryptographic hash, cyclic redundancy check, checksum, or other value as can be appreciated.

In some embodiments, the encryption application 114 may also generate additional segments 131 sharing a sequence identifier 134 with another segment 131 but having invalid integrity data 141. Instead of including an encrypted portion of a payload 117, these segments 131 may include randomly generated data, intentionally corrupted data, or other data. This increases the challenge of reassembling the payload 117 by intercepting segments 131 by a third party, but allows a client application 127 to discard these segments 131 using the integrity data 141, as will be described below.

Next, the encryption application 114 communicates the segments 131 to the client 104 via the network 107. In some embodiments, the encryption application 114 may implement a multipath or parallel routing connection to the client 104. In such an embodiment, the communication of the segments 131 may be divided amongst each of the available routes to the client 104, or divided amongst a subset of the available routes to the client 104. In such an embodiment, the encryption application 114 may communicate a segment 131 to the client 104 using a randomly selected route. In other embodiments, the encryption application 114 may communicate segments 131 to the client 104 a predefined sequence or order of routes. Segments 131 may also be communicated to the client 104 by another approach.

As the client application 127 of the client 104 obtains the segments 131, the client application 127 may perform an integrity check on the segments 131 and compare the resulting value to the integrity data 141 of the corresponding segments 131. If the values do not match, the client application 127 then discards the segment 131. Thus, the client application 127 discards both corrupted segments 131 and segments 131 generated by the encryption application 114 with intentionally invalid integrity data 141. Those segments 131 that are not discarded are then decrypted by the client application 127. This may include selecting a private encryption key 124 or symmetric encryption key 124 according to an encryption key identifier 137 included in metadata of the segment 131. This may also include selecting a private encryption key 124 or symmetric encryption key 124 according to a sequence identifier 134 included in metadata of the segment 131 by applying a modulo operation to a number of available encryption keys 124 and the sequence identifier 134. The results of decrypting the segments 131 are then reordered to generate the encrypted payload 117. The client application 127 then performs another decryption on the encrypted payload 117 to generate the original payload 117.

In a further embodiment, a particular payload 117 may need to be communicated to multiple recipient clients 104. In such an embodiment, the encryption application 114 may generate segments 131 from the payload 117 for each of the recipient clients 104. These segments 131 would then be encrypted using an encryption key 124 for a respective one of the recipient clients 104. The segments 131 may then be communicated to all of the recipient clients 104 using a broadcast or multicast message in the network 107. The segments 131 may also be communicated by another approach. For example, the segments 131 may be communicated by a non-broadcast or non-multicast approach where recipients are located at traffic flow-through locations, such as a relay. The segments 131 may also be sent to all recipients to disguise the content or volume of data being transmitted. Although a particular client 104 would receive segments 131 intended for receipt by another client 104, these segments 131 would be discarded by unintended recipients during validation, as the segments 131 could not be successfully decrypted with a valid Message Authentication Code (MAC) without the encryption key 124 of the intended recipient client 104.

In another embodiment, the encryption application 114 may communicate a payload 117 or stream of payloads 117 to multiple recipient clients 104 by generating segments 131 from a payload 117 encrypted with a symmetric encryption key 124. This symmetric encryption key 124 would not be tied to a particular client 104 or user account 121, but would rather be generated specific to a particular payload 117 or stream of payloads 117. The symmetric encryption key 124 would then be encrypted using a client 104 or user account 121 specific encryption key 124 corresponding to a particular intended recipient client 104. The encrypted symmetric encryption keys 124 are then communicated to each of the recipient clients 104 using a broadcast approach, multicast approach, or other approach set forth above. The recipient clients 104 then decrypt the received encrypted symmetric encryption key 124 using their respective encryption keys 124. As was described above, instances of the symmetric encryption key 124 encrypted using an encryption key 124 associated with a different client 104 or user account 121 would be discarded in a validation step.

The encryption application 114 then communicates the encrypted segments 131 to the recipient clients 104 using a broadcast approach, multicast approach, or other approach as was set forth above. As an intended recipient client 104 now has access to the symmetric encryption key 124, the received segments 131 are decrypted using the symmetric encryption key 124. This allows the encryption application 114 to only send the encrypted segments 131 once for all recipient clients 104, as opposed to duplicated instances of the segments 131 encrypted for each of the recipient clients 104, thereby reducing network 107 traffic and overhead.

Although the preceding discussion addresses an encryption application 114 encrypting a payload 117 for decryption by a client application 127, it is understood that the operations of the encryption application 114 may be similarly performed by the client application 127. Thus, the client application 127 may similarly encrypt a payload 117 for communication the computing environment 101 for decryption. Furthermore, although the preceding discussion addresses applying an encryption approach to the payload 117 before splitting the payload 117 into segments, it is understood that this operation may be omitted such that the unencrypted payload 117 is divided into segments 131 for subsequent encryption and communication. Additionally, it is understood that any of the metadata added to segments 131 after encryption, including the sequence identifier 134 or integrity data 141, may be added to the segment 131 prior to encryption.

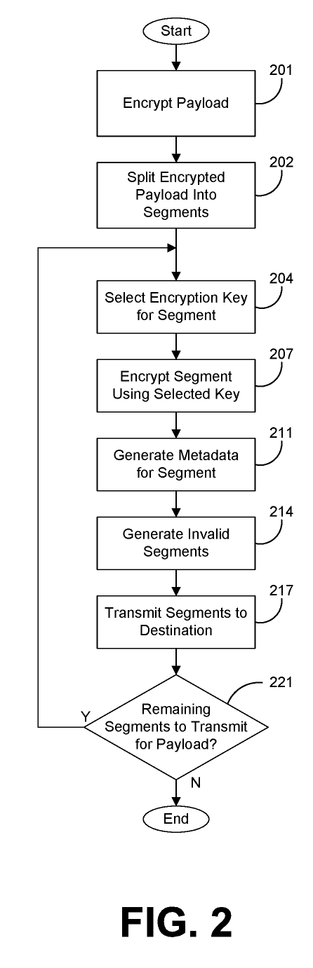

Referring next to FIG. 2, shown is a flowchart that provides one example of the operation of a portion of the encryption application 114 according to various embodiments. It is understood that the flowchart of FIG. 2 provides merely an example of the many different types of functional arrangements that may be employed to implement the operation of the portion of the encryption application 114 as described herein. As an alternative, the flowchart of FIG. 2 may be viewed as depicting an example of elements of a method implemented in the computing environment 101 (FIG. 1) according to one or more embodiments.

Beginning with box 201, the encryption application 114 encrypts a payload 117 to be communicated to a client 104. In embodiments in which the client 104 has authenticated or established a session with the computing environment 101, this may include selecting an encryption key 124 corresponding to a user account 121 of the client 104. The selected encryption key 124 is then applied to the payload 117 using a symmetric encryption algorithm, an asymmetric encryption algorithm, or another approach. This may also include applying an encryption algorithm to the payload 117 using an encryption key 124 exchanged during a handshake operation, a secure tunneling, obtained from a broker or third party, or otherwise accessed by the computing environment 101.

After encrypting the payload 117, in box 202, the encryption application 114 splits the encrypted payload 117 into multiple segments 131. In some embodiments, this includes dividing the encrypted payload 117 into segments 131 of a predefined size. In other embodiments, this includes dividing the payload 117 into segments 131 of varying size. In further embodiments, this includes dividing the payload into a predefined number of segments 131. The encryption application 114 may also split the encrypted payload 117 into segments 131 by another approach.

Once the encrypted payload 117 has been split into segments 131, the encryption algorithm 114 selects an encryption key 124 for a given segment 131. In some embodiments, the encryption key 124 is selected from a pool of encryption keys 124 assigned to a user account 121. In other embodiments, the encryption key 124 is selected from a broader pool of encryption keys 124. The encryption key 124 may be selected according to a sequence identifier 134 of a given segment 131. For example, for a pool of ordered or indexed encryption keys 124, an encryption key 124 for a given segment 131 may be selected by finding the remainder of the sequence identifier 134 divided by the total number of possible encryption keys 124, i.e. performing a modulo operation. The result would then indicate the corresponding encryption key 124 index. The encryption key 124 for a given segment 131 may be selected by performing a hashing operation as applied to one or more attributes or values of a segment 131 and similarly performing a modulo operation to identify an encryption key 124 index. In further embodiments, the encryption key 124 may be selected as a next encryption key 124 in a sequence or rotation of encryption keys 124. For example, as the segments 131 are iterated through for encryption, the sequence or rotation of encryption keys 124 may be similarly iterated through such that a next segment 131 is encrypted using a next encryption key 124 in the rotation. The sequence or rotation of encryption keys 124 may be restarted on a per-session basis or a per-payload 117 basis. The sequence or rotation may also be continual without restart.

The selected encryption key 124 is then used to encrypt the given segment 131 in box 207. Next, in box 211, the encryption application 114 generates metadata for the given segment 131. This may include encoding a sequence identifier 134 in the segment 131 indicating an ordering in a sequence of segments 131 for a particular payload 117. The sequence identifier 134 may also indicate a total number of segments 131 for a particular payload 117.

Generating the metadata may also include encoding an encryption key identifier 137 indicating which encryption key 124 was used to encrypt a particular segment. In embodiments in which asymmetric encryption was used to encrypt a segment 131 using a private encryption key 124, the encryption key identifier 137 may indicate corresponding public key for decrypting the segment 131.

Generating the metadata may further include generating integrity data 141 used to determine the validity or integrity of a segment 131. This may include calculating a hash value, cyclical redundancy check value, electronic signature, or other aggregate value based on at least a portion of the segment 131. Metadata may also be generated by another approach.

Next, in box 214, the encryption application 114 generates one or more invalid segments 131 for the given segment 131. The invalid segments 131 are encoded such that the integrity data 141 of the invalid segment 131 would fail a validation check. Thus, on receipt by a client application 127, the invalid segment 131 would be discarded. The invalid segment 131 may include a sequence identifier 134 matching the given valid segment 131.

The encryption application 114 then transmits the given segment 131 and any generated invalid segments 131 to the destination client 104 via the network 107 in box 217. In some embodiments, this may include transmitting the segments 131 across one of many parallel network 107 paths to the destination. Thus, if one path has been compromised by a malicious party, the entirety of communications between the computing environment 101 and client 104 are not compromised. Additionally, by transmitting the invalid segments 131 on a network path different from the corresponding valid segment 131, a malicious party is more likely to receive one or more invalid segments 131 and is prevented from accessing the corresponding valid segment 131.

Next, in box 221, the encryption application 114 determines if any segments 131 for a given payload 117 remain to be transmitted. If so, the process returns to box 204, where the encryption application 114 continues to encrypt and transmit segments 131 for a payload 117. If, in box 221, no segments 131 for a payload 117 remain to be transmitted, the process ends.

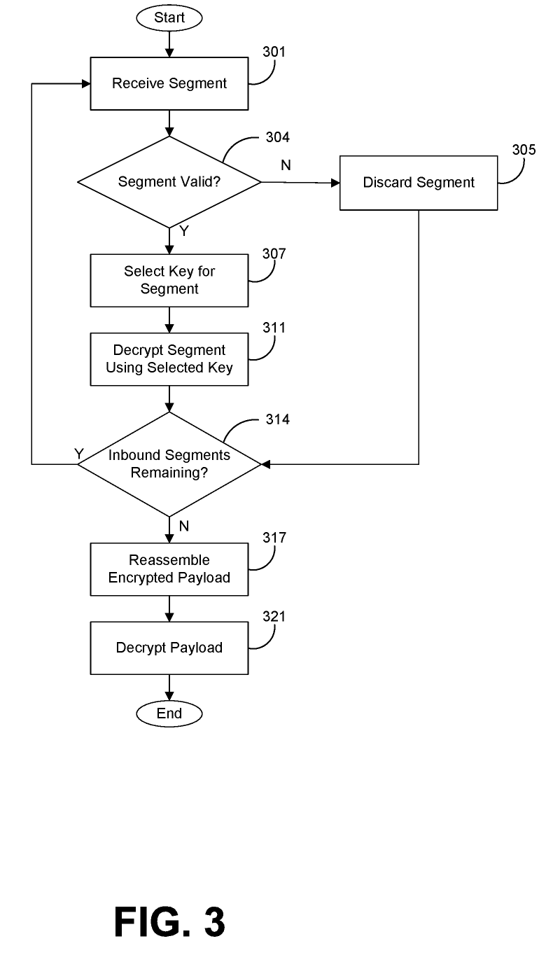

Referring next to FIG. 3, shown is a flowchart that provides one example of the operation of a portion of the client application 127 according to various embodiments. It is understood that the flowchart of FIG. 3 provides merely an example of the many different types of functional arrangements that may be employed to implement the operation of the portion of the client application 127 as described herein. As an alternative, the flowchart of FIG. 3 may be viewed as depicting an example of elements of a method implemented in the client 104 according to one or more embodiments.

Beginning with box 301, the client application 127 receives a segment 131 communicated by the encryption application 114 via the network 107. In box 304, the client application 127 determines if the received segment 131 is valid based on integrity data 141 encoded in the received segment 131. This may include calculating a hash value, checksum value, cyclical redundancy check value, electronic signature, or other value as a function of all or a portion of the received segment 131. The calculated value is then compared to the integrity data 141 of the received segment 131. If the segment 131 is invalid, which occurs when the calculated value fails to match a value indicated in the integrity data 141, the process advances to box 305 where the segment 131 is discarded. The process then advances to box 314, which will be described in further detail below.

If the segment 131 is deemed valid, which occurs when the calculated value matches the value indicated in the integrity data 141, the process advances to box 307 where the client application selects a key for decrypting the received segment. In some embodiments, this is performed according to an encryption key identifier 137 encoded in the segment 131. For example, in embodiments in which the segment 131 is encrypted according to symmetric key encryption, the client application 127 may select the encryption key 124 used to encrypt the segment 131 as identified by the encryption key identifier 137. As another example, in embodiments in which the segment 131 is encrypted according to asymmetric key encryption, the client application 127 may select a public key identified by the encryption key identifier 137, or select a public key corresponding to a private encryption key 124 identified by the encryption key identifier 137.

As with selecting an encryption key 124 for encrypting a segment 131, a key can be selected for decryption based on a sequence identifier 134 of the segment. For example, a key can be selected from a pool of keys by selecting a key from an index determined as the remainder of the sequence identifier 134 divided by a total number of key indices. The key can also be selected according to a rotation or sequence of keys, or selected by another approach.

After selecting the key, the client application 127 decrypts the received segment 131 according to the selected key in box 311. The process then advances to box 314, where the client application 127 determines whether additional segments 131 remain to be received for a given payload 117 corresponding to the received segment 131. For example, this may include determining whether additional segments 131 remain in a buffer of a network interface, the client application 127, or other portion of the client 104. This may also include determining whether all of the segments 131 for a given payload 117 have been received by comparing a number of received segments 131 to a total number of segments 131 as indicated in the sequence identifier 134, or a total number of predefined segments 131 into which payloads 117 are split.

If additional segments 131 remain to be received as determined in box 314, the process returns to box 301, where the client application 127 continues to receive and decrypt segments 131 until no additional segments 131 remain to be received for the given payload 117. The process then advances to box 317 where the client application 127 reassembles the encrypted payload 317 by ordering the data portions of segments 131 according to their sequence identifier 134. The client application 127 then decrypts the encrypted payload 117 in box 317 according to the encryption key 124 used to encrypt the payload 117 prior to its being split into segments 131. After decrypting the payload 117, the process ends.

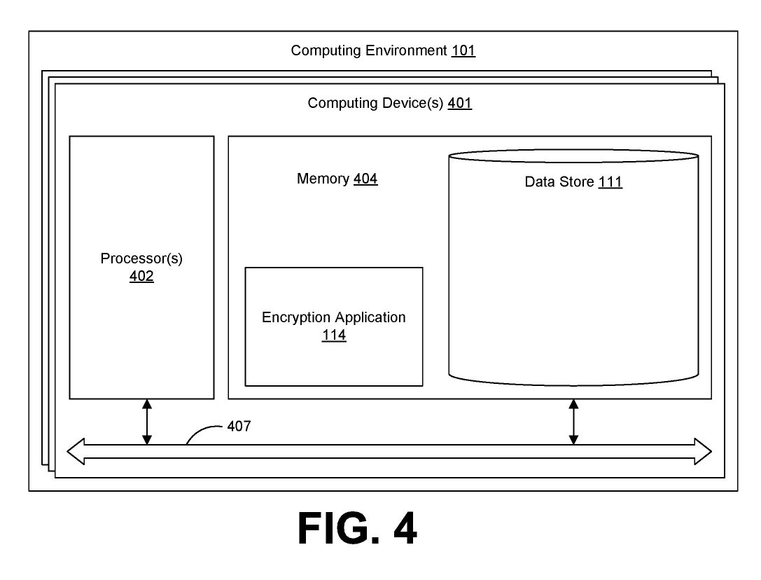

With reference to FIG. 4, shown is a schematic block diagram of the computing environment 101 according to an embodiment of the present disclosure. The computing environment 101 includes one or more computing devices 401. Each computing device 401 includes at least one processor circuit, for example, having a processor 402 and a memory 404, both of which are coupled to a local interface 407. To this end, each computing device 401 may comprise, for example, at least one server computer or like device. The local interface 407 may comprise, for example, a data bus with an accompanying address/control bus or other bus structure as can be appreciated.

Stored in the memory 404 are both data and several components that are executable by the processor 402. In particular, stored in the memory 404 and executable by the processor 402 are an encryption application 114, and potentially other applications. Also stored in the memory 404 may be a data store 111 and other data. In addition, an operating system may be stored in the memory 404 and executable by the processor 402.

It is understood that there may be other applications that are stored in the memory 404 and are executable by the processor 402 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 404 and are executable by the processor 402. In this respect, the term “executable” means a program file that is in a form that can ultimately be run by the processor 402. Examples of executable programs may be, for example, a compiled program that can be translated into machine code in a format that can be loaded into a random access portion of the memory 404 and run by the processor 402, source code that may be expressed in proper format such as object code that is capable of being loaded into a random access portion of the memory 404 and executed by the processor 402, or source code that may be interpreted by another executable program to generate instructions in a random access portion of the memory 404 to be executed by the processor 402, etc. An executable program may be stored in any portion or component of the memory 404 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 404 is defined herein as including both volatile and nonvolatile memory and data storage components. Volatile components are those that do not retain data values upon loss of power. Nonvolatile components are those that retain data upon a loss of power. Thus, the memory 404 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 402 may represent multiple processors 402 and/or multiple processor cores and the memory 404 may represent multiple memories 404 that operate in parallel processing circuits, respectively. In such a case, the local interface 407 may be an appropriate network that facilitates communication between any two of the multiple processors 402, between any processor 402 and any of the memories 404, or between any two of the memories 404, etc. The local interface 407 may comprise additional systems designed to coordinate this communication, including, for example, performing load balancing. The processor 402 may be of electrical or of some other available construction.

Although the encryption application 114 and client application 127, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2 and 3 show the functionality and operation of an implementation of portions of the encryption application 114 or client application 127, respectively. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 402 in a computer system or other system. The machine code may be converted from the source code, etc. If embodied in hardware, each block may represent a circuit or a number of interconnected circuits to implement the specified logical function(s).

Although the flowcharts of FIGS. 2 and 3 show a specific order of execution, it is understood that the order of execution may differ from that which is depicted. For example, the order of execution of two or more blocks may be scrambled relative to the order shown. Also, two or more blocks shown in succession in FIGS. 2 and 3 may be executed concurrently or with partial concurrence. Further, in some embodiments, one or more of the blocks shown in FIGS. 2 and 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the encryption application 114 and client application 127, that comprises software or code can be embodied in any non-transitory computer-readable medium for use by or in connection with an instruction execution system such as, for example, a processor 402 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the encryption application 114 and client application 127, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 401 or client 104, or in multiple computing devices in the same computing environment 101. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device comprising at least one processor and memory storing instructions that, when executed by the at least one computing device, cause the at least one computing device to at least:
generate a plurality of segments of a data payload;
select, for each of the plurality of segments, a respective encryption key from of a pool of encryption keys;
encrypt each of the plurality of segments as a function of the respective encryption key; and
communicate each of the plurality of segments to a network destination by distributing the plurality of segments amongst a plurality of network paths to the network destination.

2. The system of claim 1, wherein the pool of encryption keys are a subset of a plurality of encryption keys, and the instructions further cause the at least one computing device to at least identify the pool of encryption keys from the plurality of encryption keys based at least in part on a user account corresponding to the network destination.

3. The system of claim 1, wherein the respective encryption key is selected from the pool of encryption keys based at least in part on a sequence identifier of a respective one of the segments.

4. The system of claim 3, wherein selecting the respective encryption key from the pool of encryption comprises:
calculating an index for the pool of encryption keys based at least in part on a modulo operation applied to the sequence identifier and a total number of encryption keys in the pool of encryption keys; and
selecting the respective encryption key from the pool of encryption keys according to the index.

5. The system of claim 1, wherein instructions further cause the at least one computing device to encrypt the data payload before generating the plurality of segments.

6. The system of claim 1, wherein instructions further cause the at least one computing device to encode, in the plurality of segments, validation data facilitating a validation of the plurality of segments.

7. The system of claim 6, wherein instructions further cause the at least one computing device to at least:
generate, for at least one of the plurality of segments, a corresponding at least one invalid segment having invalid validation data; and
communicate the corresponding at least one invalid segment to the network destination.

8. The system of claim 7, wherein the at least one of the plurality of segments shares at least one sequence identifier with the corresponding at least one invalid segment.

9. The system of claim 1, wherein the respective encryption key is selected from the pool of encryption keys by, for each of the plurality of segments, selecting, as the respective encryption key, a next one of the pool of encryption keys in a rotation of use for the pool of encryption keys.

10. The system of claim 1, wherein the instructions further cause the at least one computing device to at least encode, in each of the plurality of segments, an encryption key identifier corresponding to the respective encryption key.

11. A method, comprising:
generating, by at least one computing device, a plurality of segments of a data payload;
selecting, by the at least one computing device, for each of the plurality of segments, a respective encryption key from of a pool of encryption keys;
encrypting, by the at least one computing device, each of the plurality of segments as a function of the respective encryption key; and
communicating, by the at least one computing device, each of the plurality of segments to a network destination by distributing the plurality of segments amongst a plurality of network paths to the network destination.

12. The method of claim 11, wherein the pool of encryption keys are a subset of a plurality of encryption keys, and the method further comprises identifying, by the at least one computing device, the pool of encryption keys from the plurality of encryption keys based at least in part on a user account corresponding to the network destination.

13. The method of claim 11, wherein the respective encryption key is selected from the pool of encryption keys based at least in part on a sequence identifier of a respective one of the segments.

14. The method of claim 13, wherein selecting the respective encryption key from the pool of encryption comprises:
calculating, by the at least one computing device, an index for the pool of encryption keys based at least in part on a modulo operation applied to the sequence identifier and a total number of encryption keys in the pool of encryption keys; and
selecting, by the at least one computing device, the respective encryption key from the pool of encryption keys according to the index.

15. The method of claim 11, further comprising encrypting, by the at least one computing device, the data payload before generating the plurality of segments.

16. The method of claim 11, further comprising encoding, by the at least one computing device, in the plurality of segments, validation data facilitating a validation of the plurality of segments.

17. The method of claim 16, further comprising:
generating, by the at least one computing device, for at least one of the plurality of segments, a corresponding at least one invalid segment having invalid validation data; and
communicating, by the at least one computing device, the corresponding at least one invalid segment to the network destination.

18. The method of claim 17, wherein the at least one of the plurality of segments shares at least one sequence identifier with the corresponding at least one invalid segment.

19. The method of claim 11, wherein the respective encryption key is selected from the pool of encryption keys by, for each of the plurality of segments, selecting, as the respective encryption key, a next one of the pool of encryption keys in a rotation of use for the pool of encryption keys.

20. The method of claim 11, further comprising encoding, by the at least one computing device, in each of the plurality of segments, an encryption key identifier corresponding to the respective encryption key.
